(19) United States
(12) Patent Application Publication
(10) Pub. No.: US 2013/0246314 A1
(43) Pub. Date: Sep. 19, 2013

(54) SYSTEM AND METHOD FOR DISTRIBUTING PRODUCTS

(71) Applicants: Shauna GARSHON, New Albany, OH (US); Jeff GARSHON, New Albany, OH (US)

(72) Inventors: Shauna GARSHON, New Albany, OH (US); Jeff GARSHON, New Albany, OH (US)

(73) Assignee: BRANDPERX LLC, New Albany, OH (US)

(21) Appl. No.: 13/618,579

(22) Filed: Sep. 14, 2012

Related U.S. Application Data
(60) Provisional application No. 61/535,009, filed on Sep. 15, 2011.

(51) Int. Cl. G06Q 90/00; B65D 25/00

(52) U.S. Cl. CPC G06Q 90/00; B65D 25/00
USPC 705/500; 206/232

(57) ABSTRACT

Presently disclosed is a pharmaceutical sample distribution device including a sample tray configured to contain pharmaceutical samples for distribution to patients, a pharmaceutical information compartment adapted to contain informational materials associated with the pharmaceutical samples; and a patient privacy bag dispenser adapted to dispense patient privacy bags for transporting pharmaceutical samples and informational materials. Also disclosed is a pharmaceutical product marketing system including a promotions tray configured to contain a promotional item for distribution to patients corresponding to a pharmaceutical product, and a patient privacy bag dispenser. A method for dispensing pharmaceutical samples is also disclosed.

### CROSS-REFERENCE TO RELATED APPLICATION

This application is a non-provisional of U.S. Provisional Patent Application No. 61/535,009, filed Sep. 15, 2011 and entitled SYSTEM AND METHOD FOR DISTRIBUTING PRODUCTS, the disclosure of which is incorporated herein by reference in its entirety.

### BACKGROUND AND SUMMARY

The present disclosure relates to a system and method for distributing products, and more particularly to a system and method for distributing pharmaceutical samples or promotional items and related information to physicians and patients.

The health care and pharmaceutical industry is a large part of today's society and economy. Pharmaceutical companies spend vast amounts of money, time, and effort promoting their products to both consumers and health care providers. One method that pharmaceutical companies use to market to physicians and health care providers is sending representatives to the physicians' offices or hospitals. The pharmaceutical representatives visit the physicians' offices and provide them with product samples and information associated with the products being marked for the physicians to analyze and prescribe to patients as appropriate.

Various problems exist with today's pharmaceutical sample distribution systems. A pharmaceutical representative may see a physician or health care provider every few weeks and provide multiple samples and associated information, such as pamphlets or brochures. With office space at a premium, physicians and health care providers have been challenged to keep the supplies provided by the pharmaceutical companies organized and accessible. Often, physicians receive more pharmaceutical samples that they have space to effectively store. As a result, the usefulness of the distributed samples and information is reduced.

In addition, increasing demands on physician's time have resulted in physicians and other many health care providers instituting policies, such as requiring appointments, that have the effect of limiting the pharmaceutical representatives' access to the physicians' offices. In some cases, overworked health care providers may even decline to see pharmaceutical representatives. Access to the health care providers is thus decreasing while the need for efficient and effective communication regarding pharmaceutical products continues to increase. As such, there remains a need for systems and methods of distributing pharmaceutical samples and products, as well as information associated with pharmaceutical products, that is efficient for both health care providers and pharmaceutical companies and distributors.

Presently disclosed is a system and method for efficiently distributing pharmaceutical products and information. In one embodiment, the pharmaceutical distribution device comprises a sample tray configured to contain pharmaceutical samples for distribution to patients, a pharmaceutical information compartment adapted to contain informational materials associated with the pharmaceutical samples, and a patient privacy bag dispenser adapted to dispense patient privacy bags for transporting pharmaceutical samples and informational materials.

In another embodiment, the sample tray is removable and may contain a plurality of apertures each configured to receive a pharmaceutical sample to be distributed to a patient. In addition, the sample tray may be adapted to receive more than one type of pharmaceutical sample. In one embodiment, the sample tray may be adapted to receive non-prescription products, such as cough syrups, pain relievers, vitamins, and hand sanitizers, among others. The sample tray may be adapted to contain non-prescription products that the distributor, health care provider, or physician would like to promote to customers or patients.

In another embodiment, the pharmaceutical distribution device is adapted to contain customizable pharmaceutical compartments. The customizable pharmaceutical compartments may be adapted to receive one or more types of pharmaceutical information, such as brochures or pamphlets of different sizes.

In yet another embodiment, the pharmaceutical sample distribution device includes a detachable sample tray configured to contain pharmaceutical samples for distribution to patients, a detachable pharmaceutical information compartment adapted to contain informational materials associated with the pharmaceutical samples, and a detachable patient privacy bag dispenser adapted to dispense patient privacy bags for transporting pharmaceutical samples and informational materials. In one embodiment, the privacy bag dispenser may be optional. The pharmaceutical distribution device may include a sample tray configured to contain pharmaceutical samples for distribution to patients and a pharmaceutical information compartment adapted to contain informational materials associated with the pharmaceutical samples. In another embodiment, the pharmaceutical distribution device may include a sample tray adapted to contain non-prescription samples for distribution to patients and an information compartment configured to contain informational materials associated with the non-prescription samples.

In yet another embodiment, the pharmaceutical distribution device may include a tray configured to contain informational materials associated with pharmaceutical products that cannot be easily displayed, such as refrigerated products. The distribution device may also have a compartment adapted to contain materials, and a patient privacy bag dispenser adapted to dispense patient privacy bags for transporting the materials. The compartment may contain a co-pay card, a coupon, a rebate offer, an information card or combinations of these or other items related to one or more products that are not easily displayed or provided as samples.

Also disclosed is a method of distributing pharmaceutical samples comprising the steps of providing a pharmaceutical sample distribution device having a sample tray configured to contain pharmaceutical samples for distribution to patients, a pharmaceutical information compartment adapted to contain informational materials associated with the pharmaceutical samples, and a patient privacy bag dispenser adapted to dispense patient privacy bags for transporting pharmaceutical samples and informational materials; loading the pharmaceutical sample distribution device with pharmaceutical samples, informational materials, and patient privacy bags; and delivering the loaded pharmaceutical sample device to a prescriber.

The method of distributing pharmaceutical samples may also include monitoring a supply of at least one of the pharmaceutical samples, informational materials, and patient privacy bags, and determining when the supply of at least one item reaches a predetermined threshold; and supplying a replacement quantity of the item.

Also disclosed is a pharmaceutical product marketing system comprising a promotions tray configured to contain a promotional item for distribution to patients corresponding to a pharmaceutical product, and a patient privacy bag dispenser adapted to dispense patient privacy bags for transporting pharmaceutical samples and informational materials. The promotional item may be a pharmaceutical sample, a co-pay card, a coupon, a rebate offer, an information card or combinations of these or other items related to the marketed pharmaceutical product. In various embodiment, the disclosed system and method provide a space efficient organization of materials for the distribution of the pharmaceutical samples and related information, reducing clutter in the health care providers office and improving the efficiency of the distribution process.

### BRIEF DESCRIPTION OF THE DRAWINGS

FIG. 1 is a perspective view of a first embodiment of a distribution device.

FIG. 2 is a perspective view of a second embodiment of a distribution device.

FIG. 3 is a perspective view of an embodiment of a removable sample tray.

FIG. 4 is a perspective view of a third embodiment of a distribution device.

FIG. 5 is a perspective view of a fourth embodiment of a distribution device.

### DETAILED DESCRIPTION OF THE DRAWINGS

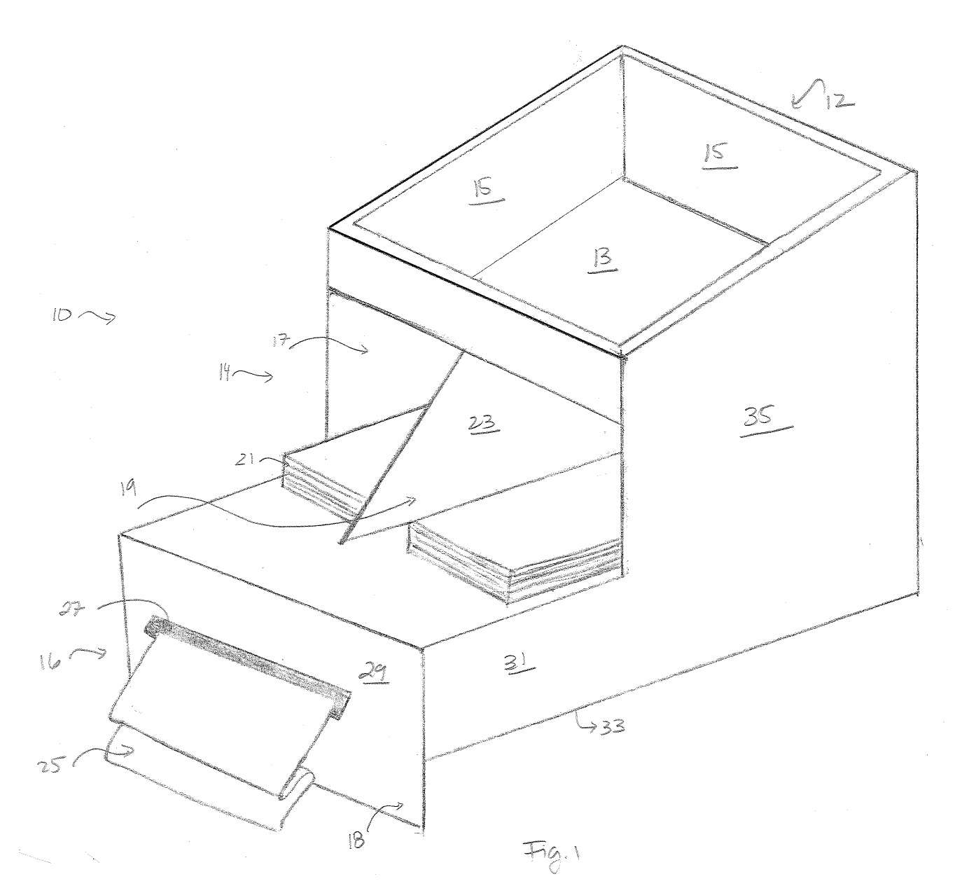

The present disclosure relates to a system and method for distributing products, and more particularly to a system and method for distributing pharmaceutical products or samples and related information to physicians and patients. Referring generally to FIGS. 1 through 5, various embodiments of the a distribution device and components are illustrated for use with the presently disclosed system and method.

Referring to FIG. 1, a first embodiment of a pharmaceutical sample distribution device is illustrated. In the embodiment shown, the sample distribution device 10 includes a distribution tray 12, a pharmaceutical information compartment 14, and a patient privacy bag dispenser 16. The distribution tray 12 may be sample tray configured to contain pharmaceutical samples for distribution to patients. In another embodiment, the tray 12 may be a promotions tray configured to contain a promotional item for distribution to patients, where the promotional item corresponds to a pharmaceutical product being marketed. In yet another embodiment, the tray 12 may be adapted to contain nonprescription products for distribution to patients. The tray 12 may be substantially rectangular as illustrated with a floor 13 and side portions 15 extending upward to define a top opening of the tray 12. In other embodiments, the tray 12 may not have side portions or may have side portions that do not extend fully around the perimeter of the tray 12. In yet another embodiment, the tray 12 may include apertures in the floor 13 configured to receive a pharmaceutical sample or nonprescription sample or promotional item to be distributed to a patient. In another embodiment, the tray 12 may be removable from the device 10. A removable tray 12 may allow for rapid replacement and restocking of the device 10 during a visit by a representative to a physician's office. In another a embodiment, tray 12 includes a removable insert (not shown) that can be preloaded with pharmaceutical samples or promotional items.

The pharmaceutical sample distribution device 10 also includes a pharmaceutical information compartment 14. In one configuration, the information compartment 14 is positioned between the tray 12 and the privacy bag dispenser 16 in a substantially vertical arrangement, however other configurations of the device are contemplated as described below. The pharmaceutical information compartment 14 may be adapted to contain informational materials associated with the pharmaceutical samples. In one embodiment, the informational materials may be marketing brochures 21 or other literature associated with a specific product. The informational materials may also include pamphlets providing information about diseases or conditions treatable by the pharmaceutical products being offered. In yet another embodiment, the informational materials may include coupons, co-pay cards, or additional instructional materials related to the pharmaceutical products. In various embodiments, the information compartment 14 is sized to accommodate one or more types of informational materials as desired. As shown in FIG. 1, the information compartment 14 may include a first information compartment 17 and a second information compartment 19 adapted to contain a second informational material. The first and second information compartments may be separated by a barrier 23. In one embodiment, the barrier 23 extends between tray 12 and privacy bag dispenser 16 and supports tray 12. In another embodiment, barrier 23 is moveable within information compartment 14 such that the sizes of first information compartment 17 and second information compartment 19 are adjustable. In other embodiments, additional barriers may be provided to form additional information compartments. In yet another embodiment, a barrier may be disposed substantially horizontally within information compartment 14, between opposing side walls of the device 10, such that that a first information compartment is provided above a second information compartment.

The pharmaceutical sample distribution device 10 also includes a patient privacy bag dispenser 16 adapted to dispense patient privacy bags 25 through slot 27. In one embodiment, a replaceable roll of patient privacy bags is disposed within dispenser 16 and bags 25 such that bags may be successively removed through slot 27. The dispenser 16 may have a front portion 29 through which slot 27 extends. The dispenser 16 may also have side portions 31. In one embodiment, front portion 29 is removable to access an interior portion of dispenser 16 allowing replacement patient privacy bags 25 to be loaded into dispenser 16. In another embodiment, one or both of side portions 31 may be opened to load replacement bags 25. The device 10 is provided with base portion 33. In one embodiment, base portion 33 forms a bottom of dispenser 16. The bottom of dispenser 16 may be opened to place bags 25 within dispenser. In another embodiment, base portion 33 of the device 10 includes an opening through which bags 25 may be inserted into dispenser 16. In yet another embodiment, dispenser 16 includes a replaceable cartridge (not shown) that is adapted to contain patient privacy bags 25. Patient privacy bags 25 may be used to provide storage and transportation for samples or other nonprescription promotional products and related informational materials that are distributed to patients. In one embodiment, the privacy bags 25 are opaque such that the contents of the bag are not easily viewable providing a patient with additional privacy. In some embodiments, the patient privacy bag dispenser 16 may be optional, or may be provided separate from the sample tray or the information compartments.

In some embodiments, the pharmaceutical sample distribution device 10 may also include a shelf tab 18 extending from a front surface of the device. The shelf tab 18 may be adapted to retain the pharmaceutical distribution device 10 adjacent a front edge of a shelf. For example, the device 10 may be placed on a shelf such that shelf tab 18 extends downward from device 10 in front of the shelf. If an attempt is made to push device 10 further onto shelf, shelf tab 18 interferes with a front edge of the shelf resisting movement of the device 10. In one embodiment, shelf tab 18 is adjustable such that tab 18 may be raised or removed if necessary. In addition, identifying information, such as brand names or product images, may be applied to shelf tab 18 as a promotional tool. In one embodiment, a pharmaceutical brand logo may be placed on shelf tab 18 to maintain visibility for prescribers and patients.

A pharmaceutical sample distribution device 10 may be formed of one or more materials. In one embodiment, the device 10 is formed of one or more pieces of cardboard or paperboard having sufficient strength to provide structural support for the device. In another embodiment, the device 10 is formed of plastic. In yet other embodiments, combinations of materials may be utilized to provide the desired properties for the device. In one example, a device 10 formed of cardboard may have a plastic skin applied to the exterior surfaces to improve durability. In another example, at least a portion of the side portions 35 of the device 10 may be adapted to display promotional materials corresponding to the pharmaceutical sample or products being promoted. In one example, the side portions may include clear plastic sleeves (not shown) for holding promotional materials. In another example, advertising material may be printed directly on the side portions of the device 10.

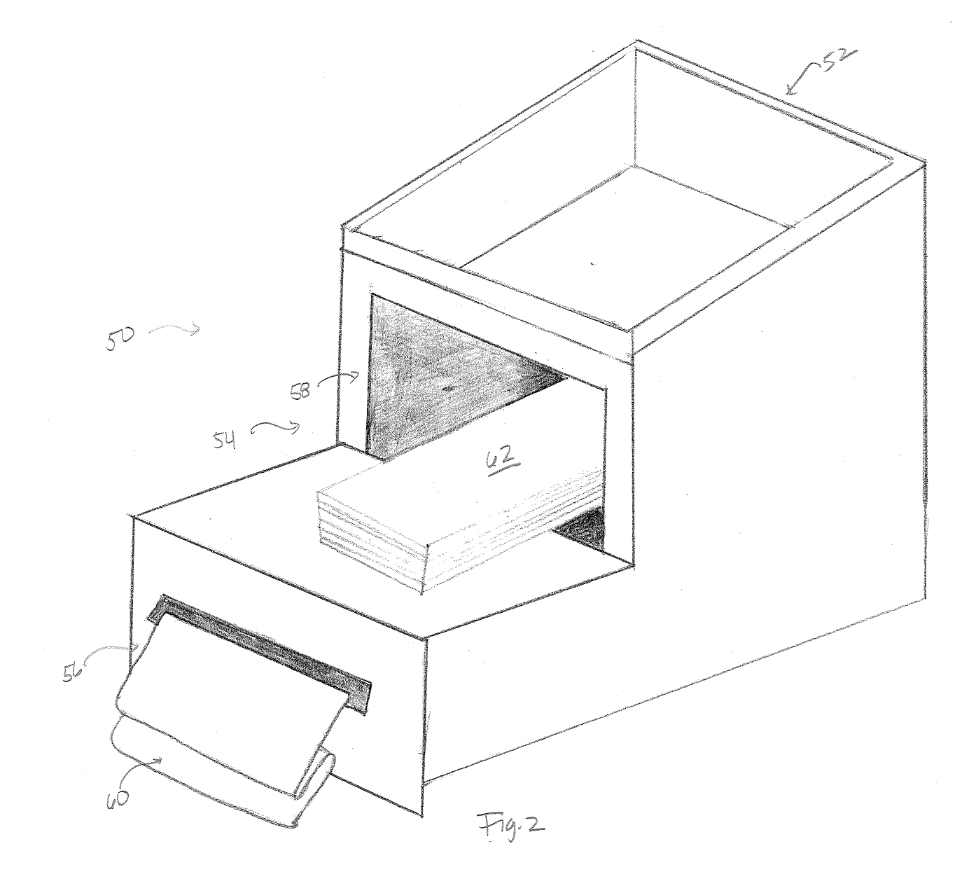

Referring now to FIG. 2, another embodiment of a pharmaceutical sample distribution device is illustrated. The device 50 includes a tray 52 configured to contain pharmaceutical samples or or nonprescription products or promotional items. The device 50 also includes an information compartment 54 for dispensing informational materials 62, and a patient privacy bag dispenser 56 for dispensing bags 60. To accommodate different quantities and sizes of samples, promotional items, and informational materials, the device 50 may be construed in a variety of sizes. As shown in FIG. 2, the device 50 is provided with a single information compartment 54. In other embodiments, the device 50 may be smaller or larger as desired. In one embodiment, the information compartment 54 includes a face plate 58 defining an opening through which informational materials 62 are dispensed. In this manner, the accessible portion of the information compartment 54 can be sized to accommodate different size information materials by changing the face plate 58 allowing a single device to accommodate a variety of applications. As a result, the pharmaceutical information compartment 54 may be adapted to fit different sizes of informational materials 62 associated with the pharmaceutical samples in the pharmaceutical sample distribution device. Furthermore, the pharmaceutical information compartment 54 may be adapted to fit different types of promotional items such as co-pay cards, coupons, rebate offers, and information cards associated with the pharmaceutical samples in the sample tray of the pharmaceutical sample distribution device.

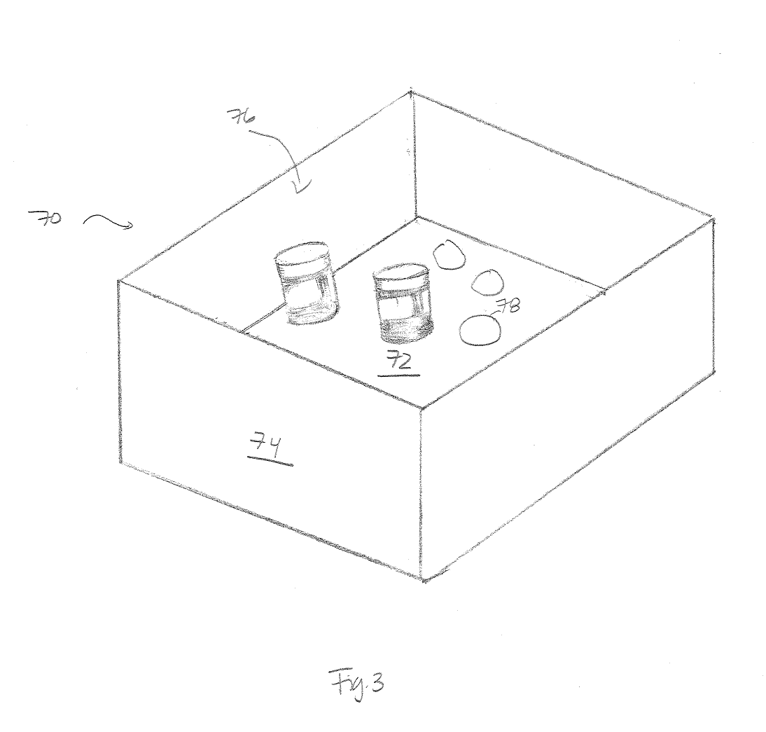

Referring now to FIG. 3, one embodiment of a removable tray 70 is illustrated for use with the present disclosure. As shown, tray 70 includes a floor portion 72 and side portions 74 extending around the perimeter of the floor portion forming a substantially rectangular structure. In one embodiment, the tray 70 may be securely attached to a device, such as those described herein. In other embodiments, the tray 70 may be placed within the device such that it rests on or in a portion of the device configured to contain pharmaceutical samples or nonprescription products or promotional materials for distribution to patients. As illustrated in FIG. 3, the tray 70 may include a plurality of apertures 78 each configured to receive a pharmaceutical sample to be distributed to patients. The apertures 78 may be configured to match the shape of the pharmaceutical samples 76 being distributed in tray 70. In other embodiments, the apertures 78 may be sized to accommodate one or more standard package sizes, such that tray 70 may be used with a variety of different samples. Furthermore, the sample tray may be adapted to contain multiple types or kinds of pharmaceutical samples. In yet another embodiment, tray 70 is provided with apertures each configured to receive a promotional item to be distributed to patients, such as a coupon or co-pay card. In some embodiments, the tray 70 may be provided with more than one style aperture such that a single tray 70 may be used with different embodiments of the device for distributing a variety of samples, promotional items or other related products.

In yet another embodiment, the pharmaceutical sample distribution device may be adapted to contain more than one type of pharmaceutical samples and informational materials associated with the pharmaceutical samples. As illustrated in FIG. 1, the pharmaceutical sample distribution device 10 may contain multiple pharmaceutical information compartments. In the same manner, tray 70 may be divided into more than one section for distributing more than one type of pharmaceutical sample or nonprescription product or promotional item. For example, the right side of the sample tray and the right side informational compartment may be dedicated to a first pharmaceutical product, whereas the left side of the sample tray and the left side pharmaceutical compartment may be assigned to a second pharmaceutical product. In one example, the first and second pharmaceutical products may be related or commonly prescribed together for treatment of certain conditions. In this manner, two or more products may be distributed using a single device, further improving space utilization in a prescriber's office.

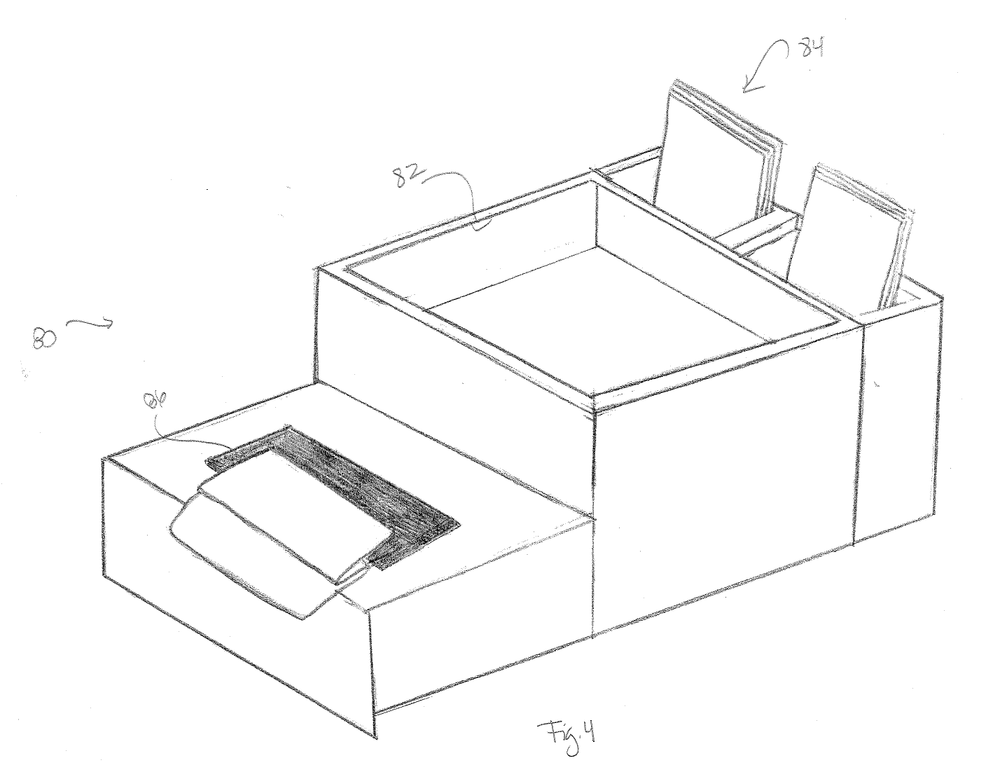

Referring now to FIG. 4, another embodiment of a distribution device 80 for use with the presently disclosed system and method is illustrated. As shown in FIG. 4, the components or sections of the device may be configured in a variety of arrangements. Additionally, the components of the device 80 may be removable such that each portion may be selectively replaced or reconfigured during the life of the device 80. Each component may be joined by connectors (not shown) extending between two components of the device 80. The device 80 illustrated in FIG. 4 includes a tray 82, a pharmaceutical information compartment 84, and a patient privacy bag dispenser 86 arranged in a generally horizontal configuration, where each of the sections may be supported by a shelf or other surface. Such a configuration may be preferred if the device may occupy a shelf or other location with height restrictions.

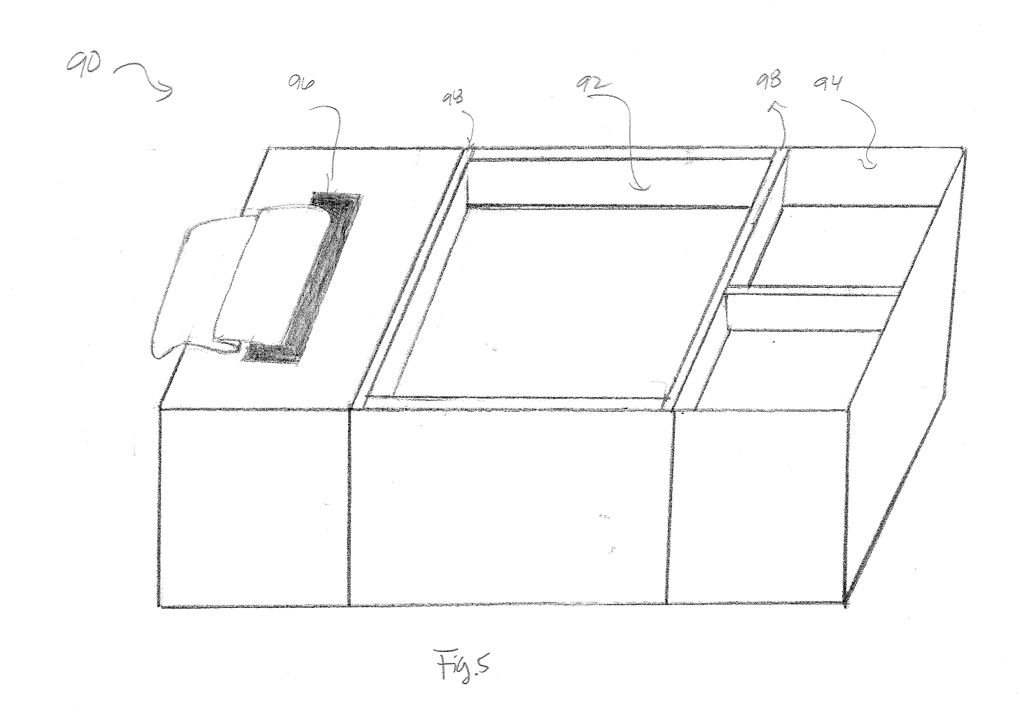

FIG. 5 illustrates yet another embodiment of a system with another configuration of the components of the system 90. As illustrated, the system 90 may include a tray 92 configured to contain pharmaceutical samples or nonprescription products or promotional items for distribution to patients disposed between an information compartment 94 and a patient privacy bag dispenser 96. In one embodiment each section of the system 90 is provided separately. The section may be joined by connectors 98 extending between two components of the system 90. The connectors 98 may be constructed of metal, plastic, cardboard, tape, or other suitable materials for joining the sections of the device. In one embodiment, the connectors 98 may be removable such that the device 90 may be disassembled and reassembled without damage to the components. In other embodiments, the sections of the system 90 may be provided with interlocking features such that the system 90 may be assembled or reassembled to fit a given space within a prescriber's office.

Also disclosed is a method for distributing pharmaceutical samples. The method comprises the steps of providing a pharmaceutical sample distribution device, loading the pharmaceutical sample distribution device with pharmaceutical samples, informational materials, and patient privacy bags, and delivering the loaded pharmaceutical sample device to a prescriber. A prescriber may be a specific person, such as a doctor or other health care provider, or may refer more generally to the offices or facilities where pharmaceutical samples and promotional materials are delivered for use by such persons. In one embodiment, the prescriber is the office of a physician specializing in the treatment of conditions corresponding to the pharmaceutical samples or promotional materials being provided. To facilitate restocking of the distribution device, the method of distributing pharmaceutical samples may also include monitoring the supply of one or more of the pharmaceutical samples, informational materials, and patient privacy bags. When the quantity of a given item in the distribution device drops below a threshold, a replacement quantity of the needed item is supplied for restocking the device. In one example, a supply of samples may be provided in a replaceable tray and mailed to the prescriber's office when the quantity of samples is depleted. In yet another embodiment, the pharmaceutical samples may be received from at least one pharmaceutical company and delivered to the prescriber to supply the device further improving the efficiency of the distribution process. The method of distributing pharmaceutical samples may also include placing at least one advertisement on an exterior surface of the pharmaceutical distribution device as previously discussed. The distribution device, loaded with samples, informational materials and privacy bags, may be delivered to the prescriber. In one embodiment, the loaded device may be mailed to the prescriber either in advance or in lieu of a visit by a pharmaceutical sales representative.

In yet another embodiment, a pharmaceutical sample distribution device disclosed herein, such as one with detachable parts or components, may be used in conjunction with the method for distributing pharmaceutical samples. When at least one of the pharmaceutical samples, informational materials, and patient privacy bags has reached a predetermined threshold, the empty detachable component of the pharmaceutical sample distribution device may be removed and replaced with a new fully loaded component. In the alternative, the sample tray, the informational compartment, and the patient privacy bag dispenser may be detached and removed completely.

Also disclosed is a pharmaceutical product marketing system comprising a promotions tray configured to contain a promotional item for distribution to patients corresponding to a pharmaceutical product; and a patient privacy bag dispenser adapted to dispense patient privacy bags for transporting pharmaceutical samples and informational materials. The promotional item may be selected from the group consisting of a pharmaceutical sample, a co-pay card, a coupon, a rebate offer, and an information card. Additionally, the promotional tray may be removable and may include a plurality of apertures each configured to receive a promotional item to be distributed to a patient.

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not different from the literal language of the claims, or if they include equivalent structural elements with insubstantial differences from the literal language of the claims.

What is claimed:

1. A pharmaceutical sample distribution device comprising:
a sample tray configured to contain pharmaceutical samples for distribution to patients;
a pharmaceutical information compartment adapted to contain informational materials associated with the pharmaceutical samples; and
a patient privacy bag dispenser adapted to dispense patient privacy bags for transporting pharmaceutical samples and informational materials.

2. The pharmaceutical sample distribution device as claimed in claim 1, where the sample tray is removable.

3. The pharmaceutical sample distribution device as claimed in claim 1, where the sample distribution tray includes a plurality of apertures each configured to receive a pharmaceutical sample to be distributed to a patient.

4. The pharmaceutical sample distribution device as claimed in claim 1 further comprising:
a second information compartment adapted to contain a second informational material.

5. The pharmaceutical sample distribution device as claimed in claim 1 further comprising:
a shelf tab extending from a front surface of the device and adapted to retain the pharmaceutical distribution device adjacent a front edge of a shelf.

6. The pharmaceutical sample distribution device as claimed in claim 1, where the sample tray comprises cardboard.

7. The pharmaceutical sample distribution device as claimed in claim 1, where the sample tray comprises plastic.

8. The pharmaceutical sample distribution device as claimed in claim 1, where the patient privacy bag dispenser includes a replaceable cartridge adapted to contain patient privacy bags.

9. The pharmaceutical sample distribution device as claimed in claim 1, where at least one of the sample tray, the pharmaceutical information compartment, and the patient privacy bag dispenser is detachable.

10. The pharmaceutical sample distribution device as claimed in claim 1, where the sample tray is loaded with pharmaceutical samples, the pharmaceutical information compartment is loaded with informational materials associated with the loaded pharmaceutical samples, and the patient privacy bag dispenser is loaded with patient privacy bags.

11. The pharmaceutical sample distribution device as claimed in claim 1 further comprising side portions adapted to display promotional materials corresponding to the pharmaceutical samples

12. A method of distributing pharmaceutical samples comprising:
providing a pharmaceutical sample distribution device having a sample tray configured to contain pharmaceutical samples for distribution to patients, a pharmaceutical information compartment adapted to contain informational materials associated with the pharmaceutical samples, and a patient privacy bag dispenser adapted to dispense patient privacy bags for transporting pharmaceutical samples and informational materials;
loading the pharmaceutical sample distribution device with pharmaceutical samples, informational materials, and patient privacy bags; and
delivering the loaded pharmaceutical sample device to a prescriber.

13. The method of distributing pharmaceutical samples as claimed in claim 12 further comprising:
determining when a quantity of at least one of the pharmaceutical samples, informational materials, and patient privacy bags reaches a predetermined threshold; and
supplying a replacement quantity of the item.

14. The method of distributing pharmaceutical samples as claimed in claim 12, where the sample tray of the pharmaceutical distribution device is a replaceable component.

15. The method of distributing pharmaceutical samples as claimed in claim 12 further comprising:
receiving pharmaceutical samples from at least one pharmaceutical company; and
delivering the pharmaceutical samples to the prescriber to supply the pharmaceutical distribution device.

16. The method of distributing pharmaceutical samples as claimed in claim 12 further comprising:
placing at least one advertisement on an exterior surface of the pharmaceutical distribution device.

17. The method of distributing pharmaceutical samples as claimed in claim 12, where the step of delivering the loaded pharmaceutical sample device to a prescriber includes mailing the loaded pharmaceutical sample device to the prescriber.

18. The method of distributing pharmaceutical samples as claimed in claim 12, where the prescriber is the office of a physician specializing in the treatment of conditions corresponding to the pharmaceutical samples.

19. A pharmaceutical product marketing system comprising:
a promotions tray configured to contain a promotional item for distribution to patients corresponding to a pharmaceutical product; and
a patient privacy bag dispenser adapted to dispense patient privacy bags for transporting pharmaceutical samples and informational materials.

20. The pharmaceutical product marketing system as claimed claim 19 further comprising:
a pharmaceutical information compartment adapted to contain informational materials associated with the pharmaceutical product.

21. The pharmaceutical product marketing system as claimed claim 19, where the pharmaceutical information compartment is disposed between the promotions tray and the patient privacy bag dispenser.

22. The pharmaceutical product marketing system as claimed claim 19, where the promotional item is selected from the group consisting of a pharmaceutical sample, a co-pay card, a coupon, a rebate offer, an information card.

23. The pharmaceutical product marketing system as claimed claim 19, where the promotional tray is removable.

24. The pharmaceutical product marketing system as claimed claim 19, where the promotions tray includes a plurality of apertures each configured to receive a promotional item to be distributed to a patient.

25. A pharmaceutical sample distribution device comprising:
means for containing and displaying pharmaceutical samples for distribution to patients;
means for containing and displaying informational materials associated with the pharmaceutical samples; and
means for dispensing patient privacy bags for transporting pharmaceutical samples and informational materials.
